(19) United States
(12) Patent Application Publication
(10) Pub. No.: US 2023/0294597 A1
(43) Pub. Date: Sep. 21, 2023

(54) PARKING ACTION NOTIFICATION DEVICE, PARKING ACTION NOTIFICATION METHOD, AND STORAGE MEDIUM

(71) Applicant: TOYOTA JIDOSHA KABUSHIKI KAISHA, Toyota-shi (JP)

(72) Inventors: Ryuji OKAMURA, Susono-shi (JP); Takanori IMAZU, Susono-shi (JP); Yoshiki FUKADA, Susono-shi (JP); Takashi HAYASHI, Mishima-shi (JP); Yuta KATAOKA, Tokyo (JP); Kohki BABA, Susono-shi (JP); Satoshi OMI, Ebina-shi (JP); Akihiro KUSUMOTO, Susono-shi (JP)

(21) Appl. No.: 18/151,723

(22) Filed: Jan. 9, 2023

(30) Foreign Application Priority Data
Mar. 18, 2022 (JP) 2022-044390

(51) Int. Cl. B60Q 1/48; B60Q 1/50; G08G 1/16

(52) U.S. Cl. CPC B60Q 1/488; B60Q 1/507; G08G 1/166; B60W 30/06

(57) ABSTRACT

A parking action notification device includes an information notification unit configured to give a notice of information to an exterior of a vehicle. The information notification unit displays parking information to the exterior of the vehicle, the parking information being relevant to a parking action of the vehicle when the vehicle performs automatic parking.

### CROSS-REFERENCE TO RELATED APPLICATION

This application claims priority to Japanese Patent Application No. 2022-044390 filed on Mar. 18, 2022, incorporated herein by reference in its entirety.

### BACKGROUND

### 1. Technical Field

The disclosure relates to a parking action notification device, a parking action notification method, and a storage medium.

### 2. Description of Related Art

Conventionally, it has been known that automatic parking of a vehicle, as exemplified by automatic valet parking, is performed using an automatic driving technology (for example, Japanese Unexamined Patent Application Publication No. 2020-135812 (JP 2020-135812 A) and Japanese Patent No. 6362738).

JP 2020-135812 A describes that a parking line is projected at the periphery of a parked vehicle using a light source of the parked vehicle in a parking place where the automatic valet parking is performed, for reducing the risk of the collision between a manual driving vehicle and the parked vehicle when the manual driving vehicle is parked by manual driving.

### SUMMARY

However, in JP 2020-135812 A, the presence of a pedestrian at the periphery of the vehicle is not considered at all. In the case where the pedestrian is present at the periphery of the vehicle that is performing the automatic parking, there is fear that a smooth execution of the automatic parking is hindered for securement of safety of the pedestrian. This problem becomes conspicuous particularly in the case where it is difficult to predict the behavior of the vehicle that performs the automatic parking.

Hence, an object of the disclosure is to smoothly execute the automatic parking of the vehicle even in the case where the pedestrian is present at the periphery of the vehicle.

The summary of the present disclosure is shown as follows.

(1) A parking action notification device including an information notification unit configured to give a notice of information to an exterior of a vehicle, in which the information notification unit displays parking information to the exterior of the vehicle, the parking information being relevant to a parking action of the vehicle when the vehicle performs automatic parking.

(2) The parking action notification device according to the above (1), in which the information notification unit displays the parking information on the vehicle.

(3) The parking action notification device according to the above (1) or (2), in which the information notification unit displays the parking information on a road surface at the periphery of the vehicle.

(4) The parking action notification device according to the above (3), in which the parking information includes a parking pathway for the vehicle.

(5) The parking action notification device according to any one of the above (1) to (4), in which the parking information includes the orientation of the vehicle when the vehicle enters a parking space.

(6) The parking action notification device according to any one of the above (1) to (5), further including a pedestrian detection unit configured to detect a pedestrian at the periphery of the vehicle, in which the information notification unit gives a notice indicating that the vehicle has recognized the pedestrian, to the pedestrian, when the information notification unit displays the parking information.

(7) The parking action notification device according to the above (6), in which the information notification unit displays information indicating that the vehicle has recognized the pedestrian, to the exterior of the vehicle.

(8) The parking action notification device according to any one of the above (1) to (7), further including a pedestrian detection unit configured to detect a pedestrian at the periphery of the vehicle, in which: the pedestrian detection unit specifies a dangerous area where the parking action of the vehicle is likely to cause danger to the pedestrian; and the information notification unit displays the dangerous area at the periphery of the pedestrian.

(9) The parking action notification device according to any one of the above (1) to (8), further including a pedestrian detection unit configured to detect a pedestrian at the periphery of the vehicle, in which the information notification unit displays the parking information when the pedestrian is detected by the pedestrian detection unit, and does not display the parking information when the pedestrian is not detected by the pedestrian detection unit.

(10) The parking action notification device according to any one of the above (1) to (9), further including a pedestrian detection unit configured to detect a pedestrian at the periphery of the vehicle, in which the information notification unit issues an alert to the pedestrian, when the pedestrian is within a predetermined distance from a parking trajectory for the vehicle.

(11) The parking action notification device according to any one of the above (1) to (10), in which when the automatic parking of the vehicle has been completed, the information notification unit gives a notice indicating that the automatic parking has been completed, to the exterior of the vehicle.

(12) The parking action notification device according to any one of the above (1) to (11), in which the information notification unit gives a notice indicating that a door of the vehicle is about to be opened for getting-off of an occupant of the vehicle, to the exterior of the vehicle.

(13) A parking action notification method that is executed by a computer, the parking action notification method comprising displaying parking information to an exterior of a vehicle, the parking information being relevant to a parking action of the vehicle when the vehicle performs automatic parking.

(14) A storage medium storing a computer program for parking action notification, the computer program causing a computer to execute displaying parking information to an exterior of a vehicle, the parking information being relevant to a parking action of the vehicle when the vehicle performs automatic parking.

With the disclosure, it is possible to smoothly execute the automatic parking of the vehicle even in the case where the pedestrian is present at the periphery of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing the configuration of a vehicle in which a parking action notification device according to a first embodiment of the disclosure is provided;

FIG. 2 is a diagram showing an example of a parking trajectory in a parking control for the vehicle;

FIG. 3 is a functional block diagram of a processor of an ECU in the first embodiment;

FIG. 4 is a flowchart showing a control routine of an information notification process in the first embodiment;

FIG. 5 is a diagram showing an example of information indicating that the parking control is executed in the vehicle;

FIG. 6 is a diagram showing an example of the information indicating that the parking control is executed in the vehicle;

FIG. 7 is a functional block diagram of a processor of an ECU in a second embodiment;

FIG. 8 is a flowchart showing a control routine of an information notification process in the second embodiment;

FIG. 9 is a diagram showing an example of information indicating that the vehicle has recognized a pedestrian;

FIG. 10 is a diagram showing an example of the information indicating that the vehicle has recognized the pedestrian;

FIG. 11 is a flowchart showing a control routine of an information notification process in a third embodiment;

FIG. 12 is a diagram showing an example of a dangerous area;

FIG. 13 is a schematic configuration diagram of a parking action notification system according to a fourth embodiment of the disclosure;

FIG. 14 is a diagram schematically showing the configuration of a server; and

FIG. 15 is a diagram schematically showing a predetermined parking area where automatic parking is performed.

### DETAILED DESCRIPTION OF EMBODIMENTS

Embodiments of the disclosure will be described below in detail with reference to the drawings. In the following description, similar constituent elements are denoted by identical reference numerals.

### First Embodiment

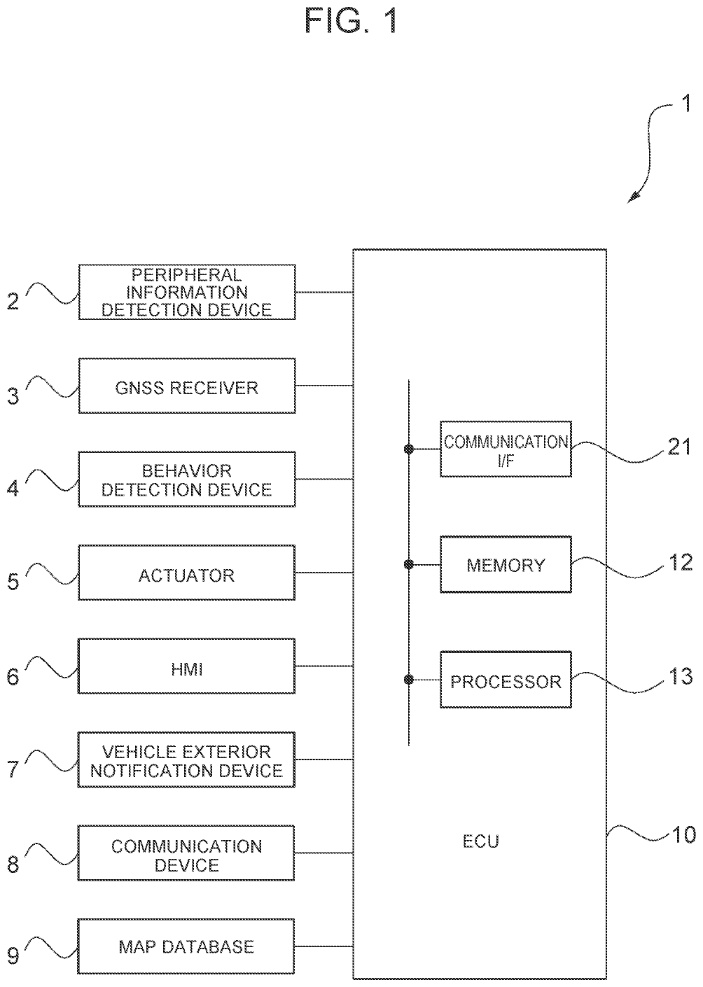

First, a first embodiment of the disclosure will be described with reference to FIG. 1 to FIG. 6. FIG. 1 is a diagram schematically showing the configuration of a vehicle 1 in which a parking action notification device according to the first embodiment of the disclosure is provided. As shown in FIG. 1, the vehicle 1 includes a peripheral information detection device 2, a GNSS receiver 3, a behavior detection device 4, an actuator 5, an HMI 6, a vehicle exterior notification device 7, a communication device 8, a map database 9, and an electronic control unit (ECU) 10. The peripheral information detection device 2, the GNSS receiver 3, the behavior detection device 4, the actuator 5, the HMI 6, the vehicle exterior notification device 7, the communication device 8, and the map database 9 are communicably connected to an ECU 10, for example, through an in-vehicle network conforming to a standard such as controller area network (CAN).

The peripheral information detection device 2 generates data (images, point cloud data, and the like) about the periphery of the vehicle 1, and detects peripheral information (for example, a peripheral vehicle, a pedestrian, a white line, and like) about the vehicle 1. Examples of the peripheral information detection device 2 includes a millimeter-wave radar, a camera (for example, a stereo camera), a laser imaging detection and ranging (LIDAR), an ultrasonic sensor (sonar), and arbitrary combinations of them. The output of the peripheral information detection device 2, that is, the peripheral information about the vehicle 1 that is detected by the peripheral information detection device 2 is sent to the ECU 10.

The GNSS receiver 3 detects the current position (for example, the latitude and longitude of the vehicle 1) of the vehicle 1, based on positioning information that is obtained from a plurality of (for example, three or more) positioning satellites. Specifically, the GNSS receiver 3 catches the positioning satellites, and receives electric waves that are transmitted from the positioning satellites. Then, the GNSS receiver 3 calculates the distances to the positioning satellites based on the differences between the transmission times and reception times about the electric waves, and detects the current position of the vehicle 1 based on the distances to the positioning satellites and the positions (trajectory information) of the positioning satellites. Specific examples of the GNSS receiver 3 include a GPS receiver. The output of the GNSS receiver 3, that is, the current position of the vehicle 1 that is detected by the GNSS receiver 3 is sent to the ECU 10.

The behavior detection device 4 detects the behavior of the vehicle 1. Examples of the behavior detection device 4 include a vehicle speed sensor, an acceleration sensor, and an angular velocity sensor. The output of the behavior detection device 4, that is, the behavior of the vehicle 1 that is detected by the behavior detection device 4 is sent to the ECU 10.

The actuator 5 actuates the vehicle 1. For example, the actuator 5 includes a drive device (for example, at least one of an internal combustion engine and an electric motor) for the acceleration of the vehicle 1, a brake actuator for the braking (deceleration) of the vehicle 1, and a steering motor for the steering of the vehicle 1. The ECU 10 controls the actuator 5, and controls the behavior of the vehicle 1. That is, the vehicle 1 is an automatic driving vehicle in which all of the acceleration, steering, and deceleration (braking) of the vehicle 1 are automatically executed, and the ECU 10 executes the autonomous traveling of the vehicle 1 using the actuator 5.

The HMI 6 exchanges information between the vehicle 1 and an occupant (for example, a driver) of the vehicle 1. The HMI 6 includes an output unit (for example, a display, a speaker, a vibration unit, and the like) that outputs information to the occupant of the vehicle 1, and an input unit (for example, a touch panel, an operation button, an operation switch, a microphone, and the like) to which information is input by the occupant of the vehicle 1. A notice of the output of the ECU 10 is given to the occupant of the vehicle 1 through the HMI 6, and the input from the occupant of the vehicle 1 is sent to the ECU 10 through the HMI 6. The HMI 6 is an example of an input device, an output device, or an input-output device. A portable terminal (a smartphone, a tablet terminal, or the like) of the occupant of the vehicle 1 may be communicably connected to the ECU 10 by wire or wireless, and may function as the HMI 6.

The vehicle exterior notification device 7 transmits information (visual information or auditory information) to the exterior of the vehicle 1. For example, the vehicle exterior notification device 7 includes a projector that projects information to the exterior (for example, a road surface) of the vehicle 1, a vehicle exterior display that is provided on a vehicle body so as to be capable of being visually recognized from the exterior of the vehicle 1, a vehicle exterior speaker that emits sound to the exterior of the vehicle 1, and the like. The ECU 10 controls the actuation state of the vehicle exterior notification device 7.

The communication device 8 can communicate with the exterior of the vehicle 1, and allows the communication between the vehicle 1 and the exterior of the vehicle 1. For example, the communication device 8 includes a wide-area wireless communicator (for example, a data communication module (DCM)) that allows wide-area wireless communication between the vehicle 1 and the exterior of the vehicle 1, a short-range wireless communicator that allows short-range wireless communication between the vehicle 1 and the exterior of the vehicle 1, and the like. The ECU 10 communicates with the exterior of the vehicle 1 using the communication device 8.

The map database 9 stores map information. The ECU 10 acquires the map information from the map database 9. The map database may be provided in the exterior (for example, a server) of the vehicle 1, and the ECU 10 may acquire the map information from the exterior of the vehicle 1.

The ECU 10 executes a variety of controls of the vehicle 1. As shown in FIG. 1, the ECU 10 includes a communication interface 21, a memory 12, and a processor 13. The communication interface 21 and the memory 12 are connected to the processor 13 through a signal line. In the embodiment, a single ECU 10 is provided. However, a plurality of ECUs each of which corresponds to a function may be provided.

The communication interface 21 includes an interface circuit for connecting the ECU 10 to the in-vehicle network. The ECU 10 is connected to other on-board devices through the communication interface 21. The communication interface 21 is an example of a communication unit of the ECU 10.

For example, the memory 12 includes a volatile semiconductor memory and a non-volatile semiconductor memory. The memory 12 stores computer programs, data, and the like that are used when a variety of processes are executed by the processor 13. The memory 12 is an example of a storage unit of the ECU 10.

The processor 13 includes a single or a plurality of central processing units (CPUs) and peripheral circuits of the CPUs. The processor 13 may further include an arithmetic circuit such as an arithmetic-logic unit or an arithmetic-numerical unit.

In the embodiment, the vehicle 1 performs automatic parking in a parking area. In the automatic parking, the behavior of the vehicle 1 at the time of parking is automatically controlled, and the vehicle 1 enters a parking space in the parking area without requiring a manual operation by the driver of the vehicle 1.

For example, availability information about parking spaces in the parking area is sent to the vehicle 1 from a server that manages the parking area, and the occupant of the vehicle 1 selects a desired available parking space through the HMI 6. As a result, the vehicle 1 moves to the vicinity of the target parking space by autonomous traveling, and executes a parking control by which the vehicle 1 enters the target parking space.

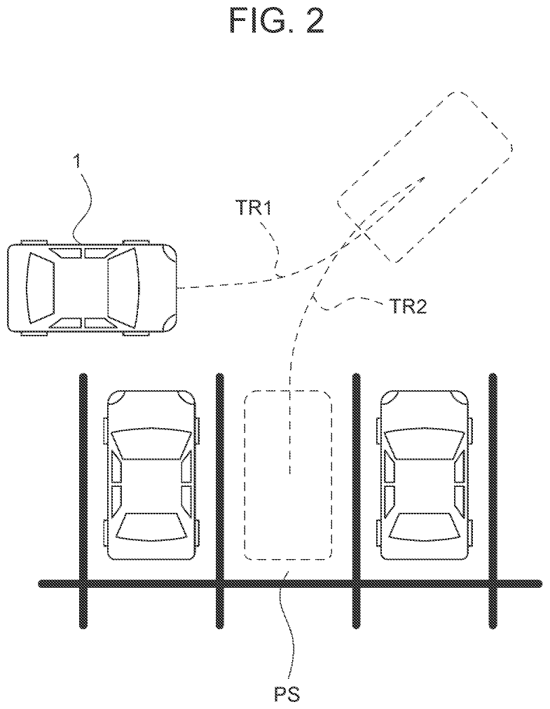

FIG. 2 is a diagram showing an example of a parking trajectory in the parking control for the vehicle 1. In the example of FIG. 2, the parking trajectory is constituted by a first traveling route TR1 when the vehicle 1 moves diagonally forward so as to get away from a parking space PS and a second traveling route TR2 when the vehicle 1 moves diagonally rearward to the parking space PS. That is, the vehicle 1 moves forward from a parking start point at the vicinity of the target parking space PS, along the first traveling route TR1, and thereafter, moves rearward along the second traveling route TR2 such that the vehicle 1 is placed in the target parking space PS.

By the above automatic parking, it is possible to liberate the occupant of the vehicle 1 from a burdensome vehicle operation for parking. However, in the case where the pedestrian is present at the periphery of the vehicle 1 that is performing the automatic parking, there is fear that a smooth execution of the automatic parking is hindered for securement of safety of the pedestrian. This problem becomes conspicuous particularly in the case where it is difficult to predict the behavior of the vehicle 1 that performs the automatic parking. Therefore, in the embodiment, the parking action notification device provided in the vehicle 1 gives a notice of information for predicting the behavior of the vehicle 1 that performs the automatic parking, to the exterior of the vehicle 1.

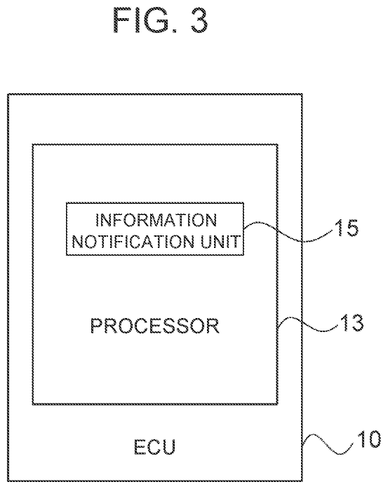

In the embodiment, the ECU 10 of the vehicle 1 functions as the parking action notification device. FIG. 3 is a functional block diagram of the processor 13 of the ECU 10 in the first embodiment. In the embodiment, the processor 13 includes an information notification unit 15. The information notification unit 15 is a functional module that is realized when the processor 13 of the ECU 10 executes a computer program stored in the memory 12 of the ECU 10. The information notification unit 15 may be realized by a dedicated arithmetic circuit that is provided in the processor 13.

The information notification unit 15 gives a notice of information to the exterior of the vehicle 1. Specifically, the information notification unit 15 displays, to the exterior of the vehicle 1, parking information (also referred to as merely “parking information” hereinafter) relevant to the parking action of the vehicle 1 when the vehicle 1 performs the automatic parking. Thereby, the pedestrian at the periphery of the vehicle 1 can easily predict the behavior of the vehicle 1 that performs the automatic parking, so that it is possible to enhance the safety of the pedestrian. Accordingly, with the embodiment, even in the case where the pedestrian is present at the periphery of the vehicle 1, it is possible to facilitate the securement of the safety of the pedestrian, and to smoothly execute the automatic parking of the vehicle 1.

Further, when the automatic parking of the vehicle 1 has been completed, the information notification unit 15 gives a notice indicating that the automatic parking of the vehicle 1 has been completed, to the exterior of the vehicle 1. Thereby, it is possible to inform the pedestrian at the periphery of the vehicle 1 that the movement of the vehicle 1 has been completed.

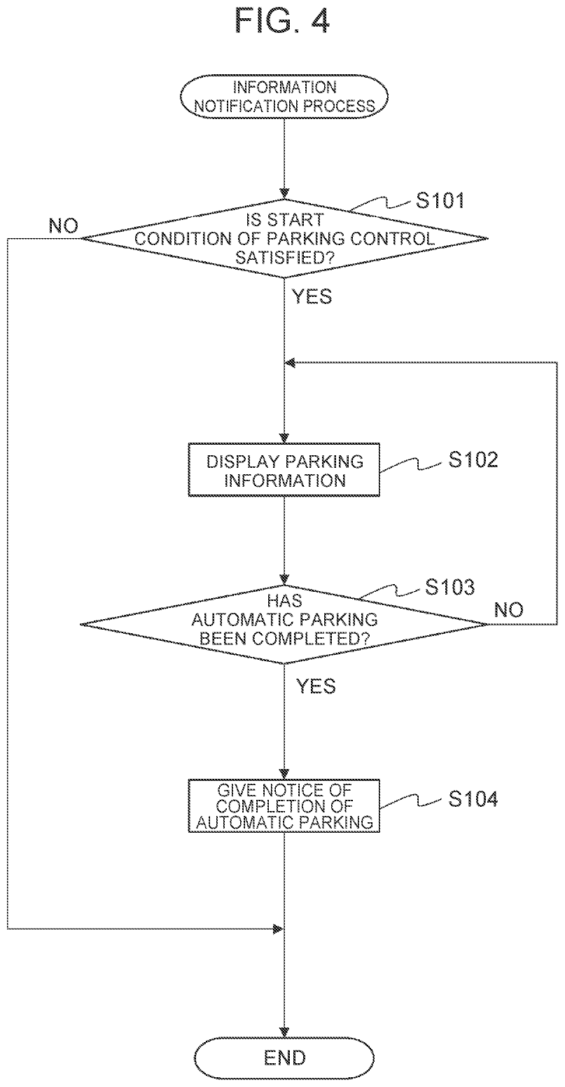

The above process will be described below in more detail with reference to a flowchart in FIG. 4. FIG. 4 is a flowchart showing a control routine of an information notification process in the first embodiment. The control routine is repeatedly executed by the processor 13 of the ECU 10, in accordance with the computer program stored in the memory 12 of the ECU 10.

First, in step S101, the information notification unit 15 determines whether a start condition of the parking control for the automatic parking is satisfied. For example, the information notification unit 15 determines that the start condition of the parking control is satisfied, when the vehicle 1 arrives at the start point for the automatic parking at the vicinity of the target parking space. The current position of the vehicle 1 in the parking place is specified based on the output of the GNSS receiver 3 and the map information in the map database 9. The current position of the vehicle 1 in the parking place may be specified based on detection results of positional markers that are provided in the parking place (for example, on road surfaces, pillars, or walls in the parking place).

In the case where it is determined in step S101 that the start condition of the parking control is not satisfied, the control routine ends. On the other hand, in the case where it is determined in step S101 that the start condition of the parking control is satisfied, the control routine proceeds to step S102.

In step S102, the information notification unit 15 displays the parking information to the exterior of the vehicle 1, using the vehicle exterior notification device 7. For example, using the vehicle exterior display or the projector as the vehicle exterior notification device 7, the information notification unit 15 displays information (for example, a symbol or a character) indicating that the parking control is being executed in the vehicle 1, to the exterior of the vehicle 1.

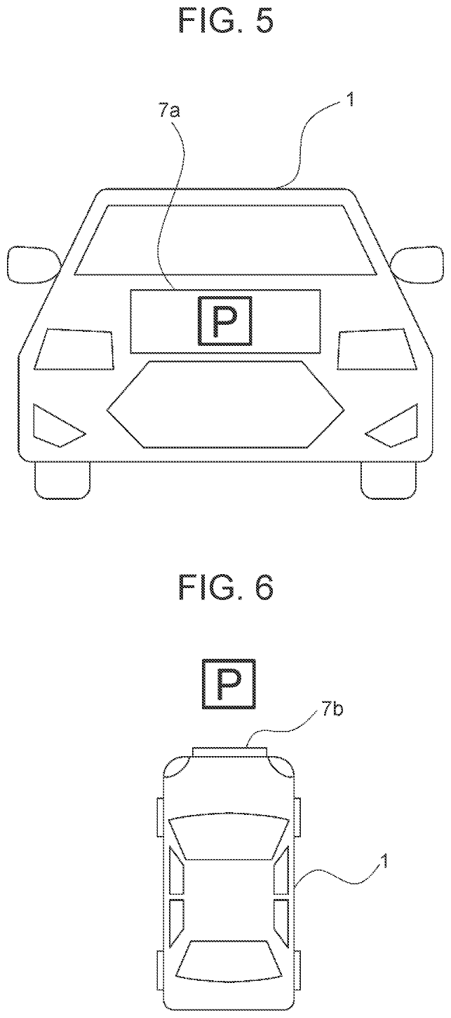

Each of FIG. 5 and FIG. 6 is a diagram showing an example of the information indicating that the parking control is being executed in the vehicle 1. In the example of FIG. 5, the information notification unit 15 displays the parking information on the vehicle 1. Specifically, a vehicle exterior display 7a is provided at a front portion of the vehicle 1, and a symbol indicating that the parking control is being executed in the vehicle 1 is displayed on the vehicle exterior display 7a. On the other hand, in the example of FIG. 6, the information notification unit 15 displays the parking information on a road surface at the periphery of the vehicle 1. Specifically, a projector 7b is provided at a front portion of the vehicle 1, and a symbol indicating that the parking control is being executed in the vehicle 1 is displayed on a road surface in front of the vehicle 1, by the projector 7b. Instead of or in addition to the symbol shown in FIG. 5 and FIG. 6, characters such as “Moving for parking” may be displayed on the vehicle exterior display 7a or the road surface.

Further, the parking information may include the orientation of the vehicle 1 when the vehicle 1 enters the parking space. That is, the information notification unit may display the orientation of the vehicle 1 when the vehicle 1 enters the parking space, to the exterior of the vehicle 1, as the parking information. Thereby, the pedestrian at the periphery of the vehicle 1 can more easily predict the behavior of the vehicle 1. For example, in the case where the vehicle 1 enters the parking space from the front side of the vehicle 1, that is, in the case where a so-called front-end parking is performed, characters such as “Moving for front-end parking” are displayed on the vehicle exterior display 7a or the road surface. On the other hand, in the case where the vehicle 1 enters the parking space from the rear side of the vehicle 1 as shown in FIG. 2, that is, in the case where a so-called rear-end parking is performed, characters such as “Moving for rear-end parking” are displayed on the vehicle exterior display 7a or the road surface.

Further, the parking information may include a parking pathway for the vehicle 1. That is, the information notification unit 15 may display a parking trajectory for the vehicle 1 in the automatic parking, on the road surface at the periphery of the vehicle 1, using the projector as the vehicle exterior notification device 7. Thereby, the pedestrian at the periphery of the vehicle 1 can know the detailed behavior of the vehicle 1. In this case, for example, projectors are provided on the front side and rear side of the vehicle 1. The parking trajectory when the vehicle 1 moves forward is displayed by the front-side projector, and the parking trajectory when the vehicle 1 moves rearward is displayed by the rear-side projector. For example, in the case where the parking trajectory for the vehicle 1 is constituted by the first traveling route TR1 and the second traveling route TR2 as shown in FIG. 2, the information notification unit 15 displays the first traveling route TR1 using the front-side projector, when the automatic parking is started, and displays the second traveling route TR2 using the rear-side projector, after the vehicle 1 moves forward along the first traveling route TR1.

Next, in step S103, the information notification unit 15 determines whether the automatic parking of the vehicle 1 has been completed. In the case where it is determined that the automatic parking of the vehicle 1 has not been completed, the control routine returns to step S102, and the display of the parking information is continued. On the other hand, in the case where it is determined that the automatic parking of the vehicle 1 has been completed, the control routine proceeds to step S104.

In step S104, the information notification unit 15 gives a notice indicating that the automatic parking has been completed, to the exterior of the vehicle 1. For example, using the vehicle exterior display or the projector as the vehicle exterior notification device 7, the information notification unit 15 displays information (for example, characters such as “Parking completed”) indicating that the automatic parking has been completed, on the vehicle exterior display or the road surface at the periphery of the vehicle 1. Further, using the vehicle exterior speaker as the vehicle exterior notification device 7, the information notification unit 15 may emit a voice such as “The parking has been completed”, to the exterior of the vehicle 1. After step S104, the control routine ends.

Further, for example, when the automatic parking of the vehicle 1 has been completed, the information notification unit 15 may give a notice indicating that a door of the vehicle 1 is about to be opened for the getting-off of the occupant of the vehicle 1, to the exterior of the vehicle 1. For example, using the vehicle exterior display or the projector as the vehicle exterior notification device 7, the information notification unit 15 displays information (for example, characters such as “Vehicle door opening”) indicating that the door of the vehicle 1 is about to be opened, on the vehicle exterior display or the road surface at the periphery of the vehicle 1. Further, using the vehicle exterior speaker as the vehicle exterior notification device 7, the information notification unit 15 may emit a voice such as “The door is about to be opened”, to the exterior of the vehicle 1. When the notification is performed, the information notification unit 15 may specify the position of the door that is about to be opened for getting-off.

### Second Embodiment

A parking action notification device according to a second embodiment is basically the same as the parking action notification device according to the first embodiment, except the points described below. Therefore, for the second embodiment of the disclosure, different parts from the first embodiment will be mainly described below.

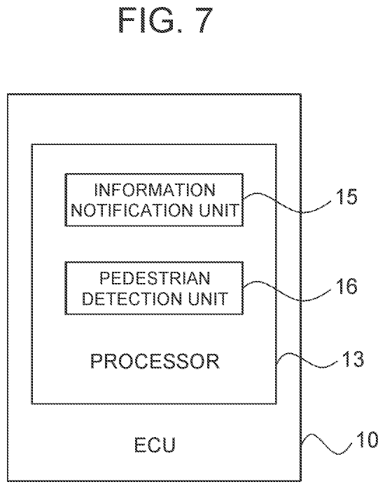

FIG. 7 is a functional block diagram of a processor 13 of an ECU 10 in the second embodiment. In the second embodiment, the processor 13 includes a pedestrian detection unit 16 in addition to an information notification unit 15. The information notification unit 15 and the pedestrian detection unit 16 are functional modules that are realized when the processor 13 of the ECU 10 executes a computer program stored in the memory 12 of the ECU 10. The information notification unit 15 and the pedestrian detection unit 16 may be realized by dedicated arithmetic circuits that are provided in the processor 13.

The pedestrian detection unit 16 detects the pedestrian at the periphery of the vehicle 1. In the case where the pedestrian is not present at the periphery of the vehicle 1 that performs the automatic parking, the need of the display of the parking information to the exterior of the vehicle 1 is low. Therefore, in the second embodiment, the information notification unit 15 displays the parking information when the pedestrian is detected by the pedestrian detection unit 16, and does not display the parking information when the pedestrian is not detected by the pedestrian detection unit 16. Thereby, it is possible to avoid a wasteful consumption of electric power due to an unnecessary display.

Further, the pedestrian at the periphery of the vehicle 1 tends to have a deep sense of unease about the behavior of the vehicle 1, in the case where it is not clear whether the vehicle 1 has recognized pedestrian's presence. Therefore, in the second embodiment, when the information notification unit 15 displays the parking information, the information notification unit 15 gives a notice indicating that the vehicle 1 has recognized the pedestrian, to the pedestrian. Thereby, it is possible to decrease pedestrian's sense of unease about the behavior of the vehicle 1.

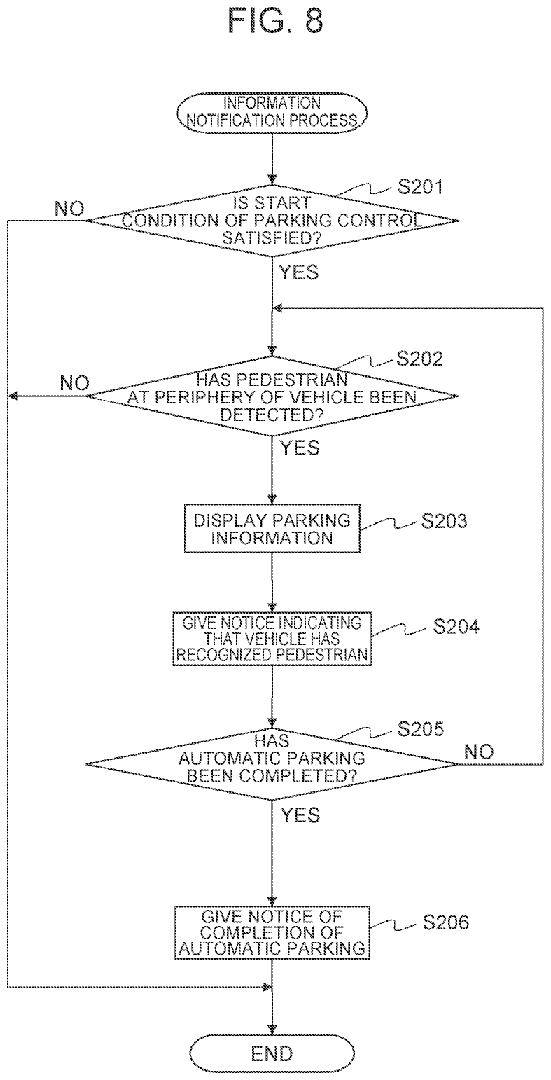

FIG. 8 is a flowchart showing a control routine of an information notification process in the second embodiment. The control routine is repeatedly executed by the processor 13 of the ECU 10, in accordance with the computer program stored in the memory 12 of the ECU 10.

First, in step S201, similarly to step S101 in FIG. 4, the information notification unit 15 determines whether the start condition of the parking control for the automatic parking is satisfied. In the case where it is determined that the start condition of the parking control is not satisfied, the control routine ends. On the other hand, in the case where it is determined that the start condition of the parking control is satisfied, the control routine proceeds to step S202.

In step S202, the information notification unit 15 determines whether the pedestrian at the periphery of the vehicle 1 has been detected by the pedestrian detection unit 16. For example, the pedestrian detection unit 16 detects the pedestrian at the periphery of the vehicle 1, based on the output of the peripheral information detection device 2. As a specific example, the pedestrian detection unit 16 detects the pedestrian using a discriminator that has performed learning in advance for outputting the presence or absence of the pedestrian from an image generated by the peripheral information detection device 2 (camera). Examples of such a discriminator include machine learning models such as a neural network, a support vector machine, and a random forest.

In the case where it is determined in step S202 that the pedestrian at the periphery of the vehicle 1 has not been detected, the control routine ends. On the other hand, in the case where it is determined in step S202 that the pedestrian at the periphery of the vehicle 1 has been detected, the control routine proceeds to step S203.

In step S203, similarly to step S102 in FIG. 4, the information notification unit 15 displays the parking information to the exterior of the vehicle 1, using the vehicle exterior notification device 7.

Next, in step S204, using the vehicle exterior notification device 7, the information notification unit 15 gives a notice indicating that the vehicle 1 has recognized the pedestrian, to the pedestrian. For example, using the vehicle exterior or the projector as the vehicle exterior notification device 7, the information notification unit 15 displays information (for example, a symbol or a character) indicating that the vehicle 1 has recognized the pedestrian, to the exterior of the vehicle 1.

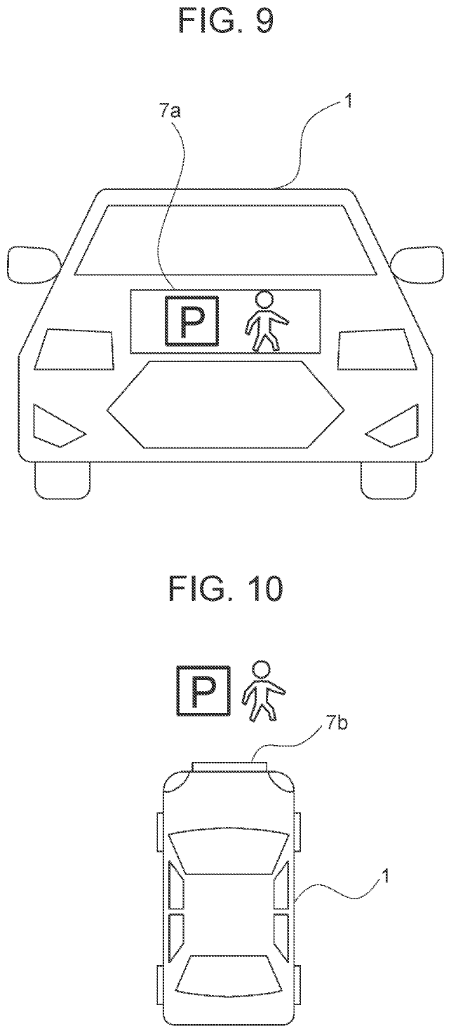

Each of FIG. 9 and FIG. 10 is a diagram showing an example of the information indicating that the vehicle 1 has recognized the pedestrian. In the example of FIG. 9, a symbol indicating that the parking control is being executed in the vehicle 1 and a symbol indicating that the vehicle 1 has recognized the pedestrian are displayed on the vehicle exterior display 7a. On the other hand, in the example of FIG. 10, a symbol indicating that the parking control is being executed in the vehicle 1 and a symbol indicating that the vehicle 1 has recognized the pedestrian are displayed on a road surface in front of the vehicle 1, by the projector 7b. Instead of or in addition to the symbols shown in FIG. 9 and FIG. 10, characters such as “Moving for parking” and “Pedestrian detected” may be displayed on the vehicle exterior display 7a or the road surface.

Further, for giving the notice indicating that the vehicle 1 has recognized the pedestrian, to the pedestrian, the information notification unit 15 may irradiate the pedestrian (for example, the feet of the pedestrian), using the projector as the vehicle exterior notification device 7. Further, using the vehicle exterior speaker as the vehicle exterior notification device 7, the information notification unit 15 may emit a voice such as “The pedestrian has been recognized”, to the exterior of the vehicle 1. Further, the information notification unit 15 may send the information indicating that the vehicle 1 has recognized the pedestrian, to a wearable terminal (a watch-type terminal (smartwatch), a wristband-type terminal, or the like) of the pedestrian, by a short-range wireless communication (Bluetooth (R), ZigBee (R), or the like). In this case, for example, the information notification unit 15 sends a signal for vibrating the wearable terminal of the pedestrian, to the wearable terminal.

After step S204, in step S205, the information notification unit 15 determines whether the automatic parking of the vehicle 1 has been completed, similarly to step S103 in FIG. 4. In the case where it is determined that the automatic parking of the vehicle 1 has not been completed, the control routine returns to step S202, and steps S202 to S204 are executed again. On the other hand, in the case where it is determined that the automatic parking of the vehicle 1 has been completed, the control routine proceeds to step S206.

In step S206, similarly to step S104 in FIG. 4, the information notification unit 15 gives the notice indicating that the automatic parking has been completed, to the exterior of the vehicle 1. After the step S206, the control routine ends.

### Third Embodiment

A parking action notification device according to a third embodiment is basically the same as the parking action notification device according to the second embodiment, except the points described below. Therefore, for the third embodiment of the disclosure, different parts from the second embodiment will be mainly described below.

In the third embodiment, similarly to the second embodiment, a processor 13 of an ECU 10 includes an information notification unit 15 and a pedestrian detection unit 16. As described above, the pedestrian detection unit 16 detects the pedestrian at the periphery of the vehicle 1. Further, in the third embodiment, the pedestrian detection unit 16 specifies a dangerous area where the parking action of the vehicle 1 is likely to cause danger to the pedestrian at the periphery of the vehicle 1, and the information notification unit 15 displays the dangerous area at the periphery of the pedestrian. Thereby, it is possible to restrain the pedestrian from getting close to the dangerous area, and to further enhance the safety of the pedestrian at the time of the automatic parking.

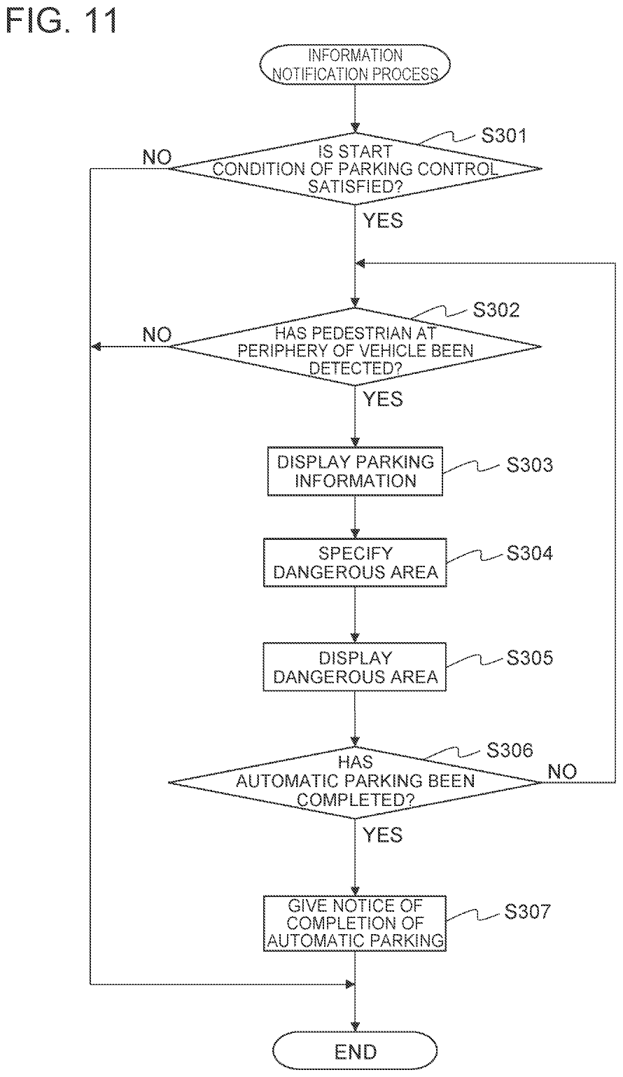

FIG. 11 is a flowchart showing a control routine of an information notification process in the third embodiment. The control routine is repeatedly executed by the processor 13 of the ECU 10, in accordance with a computer program stored in the memory 12 of the ECU 10.

First, in step S301, similarly to step S201 in FIG. 8, the information notification unit 15 determines whether the start condition of the parking control for the automatic parking is satisfied. In the case where it is determined that the start condition of the parking control is not satisfied, the control routine ends. On the other hand, in the case where it is determined that the start condition of the parking control is satisfied, the control routine proceeds to step S302.

In step S302, similarly to step S202 in FIG. 8, the information notification unit 15 determines whether the pedestrian at the periphery of the vehicle 1 has been detected by the pedestrian detection unit 16. In the case where it is determined that the pedestrian at the periphery of the vehicle 1 has not been detected, the control routine ends. On the other hand, in the case where it is determined that the pedestrian at the periphery of the vehicle 1 has been detected, the control routine proceeds to step S303.

In step S303, similarly to step S203 in FIG. 8, the information notification unit 15 displays the parking information to the exterior of the vehicle 1, using the vehicle exterior notification device 7.

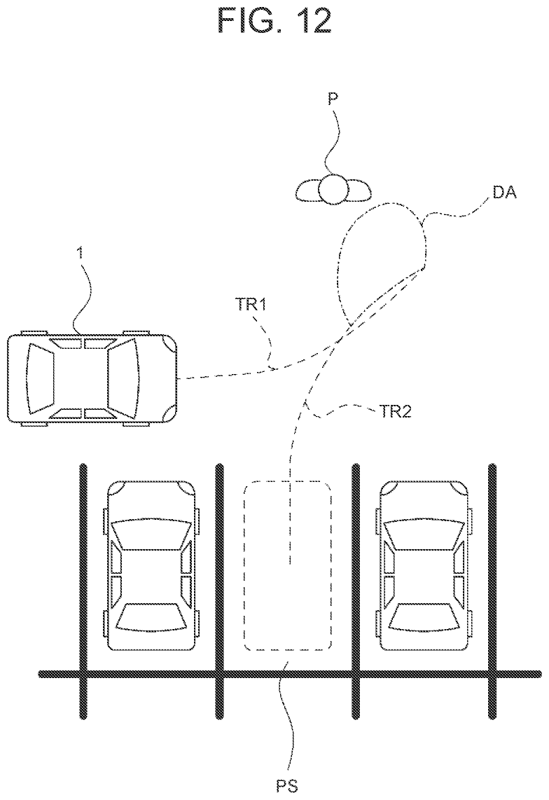

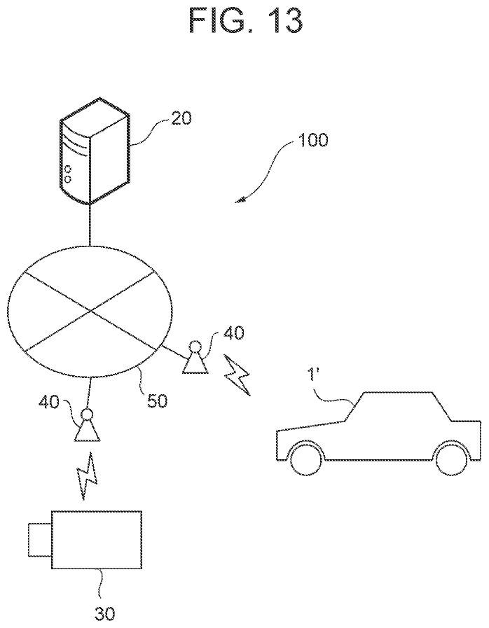

Next, in step S304, the pedestrian detection unit 16 specifies the dangerous area where the parking action of the vehicle 1 is likely to cause danger to the pedestrian at the periphery of the vehicle 1. For example, as the dangerous area, the pedestrian detection unit 16 sets a range that contains the parking trajectory for the vehicle 1 in the automatic parking and in which the distance from the pedestrian is equal to or shorter than a predetermined distance. FIG. 12 is a diagram showing an example of the dangerous area. In FIG. 12, a dangerous area DA at the periphery of a pedestrian P is shown by a one-dot chain line. Further, as the dangerous area, the pedestrian detection unit 16 may set a range that is covered by the vehicle 1 when the vehicle 1 moves along the parking trajectory.

Next, in step S305, the information notification unit 15 displays the dangerous area at the periphery of the pedestrian, using the vehicle exterior notification device 7. For example, the information notification unit 15 irradiates the whole of the dangerous area or displays the border of the dangerous area, using the projector as the vehicle exterior notification device 7. In the case where the pedestrian is within a predetermined distance from the parking trajectory for the vehicle 1, for example, in the case where the pedestrian is within the dangerous area, the information notification unit 15 may issue an alert to the pedestrian, using the vehicle exterior notification device 7 (for example, the vehicle exterior speaker). Thereby, it is possible to prompt the pedestrian to move, and to restrain the pedestrian from hindering the automatic parking.

Next, in step S306, similarly to step S205 in FIG. 8, the information notification unit 15 determines whether the automatic parking of the vehicle 1 has been completed. In the case where it is determined that the automatic parking of the vehicle 1 has not been completed, the control routine returns to step S302, and steps S302 to S305 are executed again. On the other hand, in the case where it is determined that the automatic parking of the vehicle 1 has been completed, the control routine proceeds to step S307.

In step S307, similarly to step S206 in FIG. 8, the information notification unit 15 gives the notice indicating that the automatic parking has been completed, to the exterior of the vehicle 1. After step S307, the control routine ends.

### Fourth Embodiment

A parking action notification device according to a fourth embodiment is basically the same as the parking action notification device according to the first embodiment, except the points described below. Therefore, for the fourth embodiment of the disclosure, different parts from the first embodiment will be mainly described below.

FIG. 13 is a schematic configuration diagram of a parking action notification system 100 according to the fourth embodiment of the disclosure. The parking action notification system 100 includes a server 20 and at least one projector 30. The server 20 can communicate with the projector 30 and a vehicle 1′, through a wireless base station 40 such as a macro cell or a small cell and a communication network 50 such as an internet network or a carrier network.

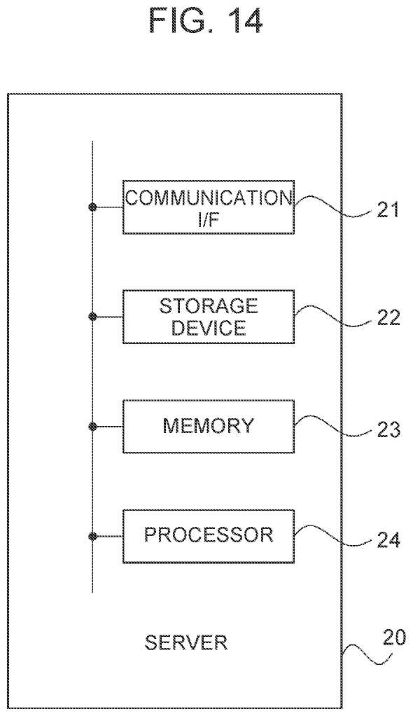

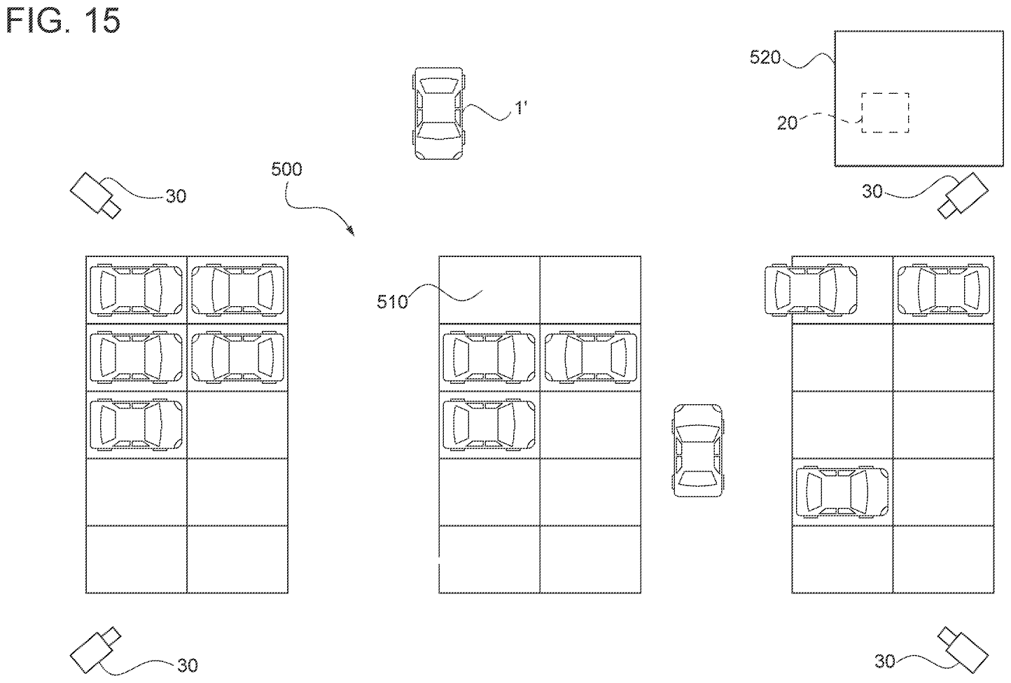

FIG. 14 is a diagram schematically showing the configuration of the server 20. The server 20 includes a communication interface 21, a storage device 22, a memory 23, and a processor 24. The communication interface 21, the storage device 22, and the memory 23 are connected to the processor 24 through a signal line. The server 20 may include an input device such as a keyboard and a mouse, an output device such as a display, and the like. Further, the server 20 may be constituted by a plurality of computers.

The communication interface 21 includes an interface circuit for connecting the server 20 to the communication network 50. The communication interface 21 is an example of a communication unit of the server 20.

For example, the storage device 22 includes a hard disk drive (HDD), a solid-state drive (SSD), or an optical recording medium and an access device for the optical recording medium. The storage device 22 stores a variety of data, and for example, stores computer programs and the like by which the processor 24 executes a variety of processes. The storage device 22 is an example of a storage unit of the server 20.

The memory 23 includes a non-volatile semiconductor memory (for example, a RAM). For example, the memory 23 temporarily stores a variety of data and the like that are used when a variety of processes are executed by the processor 24. The memory 23 is another example of the storage unit of the server 20.

The processor 24 includes a single or a plurality of CPUs and peripheral circuits of the CPUs. The processor 24 may further include another arithmetic circuit such as an arithmetic-logic unit, an arithmetic-numerical unit, or a graphics processing unit.

The vehicle 1′ is an automatic driving vehicle in which all of the acceleration, steering, and deceleration (braking) of the vehicle 1′ are automatically executed, and has a known configuration for executing the automatic driving, similarly to the vehicle 1 in the first embodiment. The vehicle 1′ performs the automatic parking in a predetermined parking area, based on an instruction from the server 20.

FIG. 15 is a diagram schematically showing a predetermined parking area 500 where the automatic parking is performed. For example, the parking area 500 is a parking place in a facility such as an airport, a station, an amusement park, a hospital, a stadium, or a shopping center. The parking area 500 includes a plurality of parking spaces 510 at each of which the vehicle 1′ is parked.

For example, the server 20 is disposed in a parking management center 520 that is provided near the parking spaces 510, and manages the automatic parking of the vehicle 1′ in the parking area 500. When the vehicle 1′ arrives at an entrance of the parking area 500, the server 20 gives an instruction about an available parking space 510 assigned to the vehicle 1′ and a traveling route to the parking space 510, to the vehicle 1′. The vehicle 1′ performs autonomous traveling along the traveling route, and enters the target parking space 510 by the automatic parking.

However, in the case where the pedestrian is present at the periphery of the vehicle 1′ that is performing the automatic parking, there is fear that a smooth execution of the automatic parking is hindered for securement of safety of the pedestrian. This problem becomes conspicuous particularly in the case where it is difficult to predict the behavior of the vehicle 1′ that performs the automatic parking.

Therefore, in the fourth embodiment, the server 20 gives a notice of information for predicting the behavior of the vehicle 1′ that performs the automatic parking, to the exterior of the vehicle 1′. That is, in the fourth embodiment, the server 20 functions as the parking action notification device, and the processor 24 of the server 20 includes the information notification unit 15. In this case, the information notification unit 15 is a functional module that is realized when the processor 24 of the server 20 executes a computer program stored in the storage device 22 of the server 20.

The information notification unit 15 displays, to the exterior of the vehicle 1′, parking information relevant to the parking action of the vehicle 1′ when the vehicle 1′ performs the automatic parking. As shown in FIG. 13, the server 20 can communicate with the projector 30, and the information notification unit 15 displays the parking information using the projector 30.

The projector 30 is provided in the parking area where the automatic parking of the vehicle 1′ is performed, and projects the information to the exterior (for example, a road surface) of the vehicle 1′ in the parking area, based on an instruction from the server 20. In the example of FIG. 15, in the parking area 500, a plurality of (four) projectors 30 is disposed at four corners of the parking area 500, and projects the information in the whole of the parking area 500 in cooperation. For example, the projector 30 includes a projection unit that can turn, and can change the projection position in the parking area 500. The projector 30 may be configured to change the projection position by moving in the parking area 500.

In the fourth embodiment, the control routine of the information notification process in FIG. 4 is executed by the processor 24 of the server 20. First, in step S101, the information notification unit 15 determines whether the start condition of the parking control for the automatic parking is satisfied in the vehicle 1′. For example, when the vehicle 1′ has given a notice of the start of the automatic parking to the server 20, the information notification unit 15 determines that the start condition of the parking control is satisfied. The position information (for example, the output of the GNSS receiver 3) about the vehicle 1′ may be periodically sent to the server 20, and the information notification unit 15 may determine that the start condition of the parking control is satisfied, when the vehicle 1′ arrives at the start point for the automatic parking at the vicinity of the target parking space 510.

In the case where it is determined in step S101 that the start condition of the parking control is not satisfied, the control routine ends. On the other hand, in the case where it is determined in step S101 that the start condition of the parking control is satisfied, the control routine proceeds to step S102.

In step S102, the information notification unit 15 displays the parking information to the exterior of the vehicle 1′, using the projector 30. For example, the information notification unit 15 selects a projector 30 that displays the parking information, from the projectors 30 provided in the parking area 500, and gives an instruction about the projection position, to the selected projector 30. As a result, for example, the projector 30 displays the information shown in FIG. 6, on a road surface at the periphery of the vehicle 1′.

Next, in step S103, the information notification unit 15 determines whether the automatic parking of the vehicle 1′ has been completed. For example, the information notification unit 15 determines that the automatic parking of the vehicle 1′ has been completed, when the vehicle 1′ has given a notice of the completion of the automatic parking to the server 20. The position information about the vehicle 1′ may be periodically sent to the server 20, and the information notification unit 15 may determine that the automatic parking of the vehicle 1′ has been completed, when the vehicle 1′ has been placed in the target parking space 510.

In the case where it is determined in step S103 that the automatic parking of the vehicle 1′ has not been completed, the control routine returns to step S102, and the display of the parking information is continued. On the other hand, in the case where it is determined in step S103 that the automatic parking of the vehicle 1′ has been completed, the control routine proceeds to step S104.

In step S104, the information notification unit 15 gives a notice indicating that the automatic parking has been completed, to the exterior of the vehicle 1′. For example, using the projector 30, the information notification unit 15 displays information (for example, characters such as “Parking completed”) indicating that the automatic parking has been completed, on the road surface at the periphery of the vehicle 1′. Further, using a speaker that is provided in the parking area 500, the information notification unit 15 may emit a voice such as “The parking has been completed”, to the exterior of the vehicle 1′. After the step S104, the control routine ends.

Further, for example, when the automatic parking of the vehicle 1′ has been completed, the information notification unit 15 may give a notice indicating that a door of the vehicle 1′ is about to be opened for the getting-off of the occupant of the vehicle 1′, to the exterior of the vehicle 1′. For example, using the projector 30, the information notification unit 15 displays information (for example, characters such as “Vehicle door opening”) indicating that the door of the vehicle 1′ is about to be opened, on the road surface at the periphery of the vehicle 1′. Further, using the speaker that is provided in the parking area 500, the information notification unit 15 may emit a voice such as “The door is about to be opened”, to the exterior of the vehicle 1′. When the notification is performed, the information notification unit 15 may specify the position of the door that is about to be opened for getting-off.

Further, the information notification unit 15 may display the parking information on the vehicle 1′. Specifically, the information notification unit 15 may display the parking information on the vehicle 1′, by projecting light on the vehicle 1′ (for example, an outer surface of the vehicle body) using the projector 30. Further, the information notification unit 15 may display the parking information on the road surface at the periphery of the vehicle 1′, using an irradiation device (for example, a plurality of LEDs) that is provided on the road surface of the parking area 500.

### OTHER EMBODIMENTS

Preferred embodiments according to the disclosure have been described above. The disclosure is not limited to the embodiments, and various modifications and alterations can be made within the description of the claims.

For example, the automatic parking of the vehicles 1, 1′ may be performed with no person, similarly to automatic valet parking. That is, after the occupant gets off the vehicle 1 or 1′, the vehicle 1 or 1′ moves to the vicinity of the target parking space by autonomous traveling, and the parking control for placing the vehicle 1 or 1′ in the target parking space may be executed. Further, the driver of the vehicle 1 or 1′ may move the vehicle 1 or 1′ by manual driving, until the automatic parking of the vehicle 1 or 1′ is started at the vicinity of the parking space.

Further, computer programs that cause a computer to realize the functions of the units included in the processor 13 of the ECU 10 or the processor 24 of the server 20 may be provided while being stored in a computer-readable recording medium (storage medium). Examples of the computer-readable recording medium (storage medium) include a magnetic recording medium, an optical recording medium, and a semiconductor memory.

The above-described embodiments can be arbitrarily combined to be carried out. For example, in the case where the second embodiment or third embodiment and the fourth embodiment are combined, the processor 24 of the server 20 includes the information notification unit 15 and the pedestrian detection unit 16, and the control routine in FIG. 4 or FIG. 8 is executed by the processor 24 of the server 20. In this case, for example, the output of the peripheral information detection device 2 of the vehicle 1′ is periodically sent to the server 20, and the pedestrian at the periphery of the vehicle 1′ is detected based on the output of the pedestrian detection unit 16. Further, the pedestrian detection unit 16 may detect the pedestrian at the periphery of the vehicle 1′, based on the output of a camera or the like that is provided in the parking area 500.

Further, in the case where the second embodiment and the third embodiment are combined, step S204 in FIG. 8 is executed between step S303 and step S304, in the control routine of the information notification process in FIG. 11, for example.

What is claimed is:

1. A parking action notification device comprising an information notification unit configured to give a notice of information to an exterior of a vehicle, wherein
the information notification unit displays parking information to the exterior of the vehicle, the parking information being relevant to a parking action of the vehicle when the vehicle performs automatic parking.

2. The parking action notification device according to claim 1, wherein the information notification unit displays the parking information on the vehicle.

3. The parking action notification device according to claim 1, wherein the information notification unit displays the parking information on a road surface at a periphery of the vehicle.

4. The parking action notification device according to claim 3, wherein the parking information includes a parking pathway for the vehicle.

5. The parking action notification device according to claim 1, wherein the parking information includes an orientation of the vehicle when the vehicle enters a parking space.

6. The parking action notification device according to claim 1, further comprising a pedestrian detection unit configured to detect a pedestrian at a periphery of the vehicle, wherein
the information notification unit gives a notice indicating that the vehicle has recognized the pedestrian, to the pedestrian, when the information notification unit displays the parking information.

7. The parking action notification device according to claim 6, wherein the information notification unit displays information indicating that the vehicle has recognized the pedestrian, to the exterior of the vehicle.

8. The parking action notification device according to claim 1, further comprising a pedestrian detection unit configured to detect a pedestrian at a periphery of the vehicle, wherein:
the pedestrian detection unit specifies a dangerous area where the parking action of the vehicle is likely to cause danger to the pedestrian; and
the information notification unit displays the dangerous area at a periphery of the pedestrian.

9. The parking action notification device according to claim 1, further comprising a pedestrian detection unit configured to detect a pedestrian at a periphery of the vehicle, wherein
the information notification unit displays the parking information when the pedestrian is detected by the pedestrian detection unit, and does not display the parking information when the pedestrian is not detected by the pedestrian detection unit.

10. The parking action notification device according to claim 1, further comprising a pedestrian detection unit configured to detect a pedestrian at a periphery of the vehicle, wherein
the information notification unit issues an alert to the pedestrian, when the pedestrian is within a predetermined distance from a parking trajectory for the vehicle.

11. The parking action notification device according to claim 1, wherein when the automatic parking of the vehicle has been completed, the information notification unit gives a notice indicating that the automatic parking has been completed, to the exterior of the vehicle.

12. The parking action notification device according to claim 1, wherein the information notification unit gives a notice indicating that a door of the vehicle is about to be opened for getting-off of an occupant of the vehicle, to the exterior of the vehicle.

13. A parking action notification method that is executed by a computer, the parking action notification method comprising displaying parking information to an exterior of a vehicle, the parking information being relevant to a parking action of the vehicle when the vehicle performs automatic parking.

14. A non-transitory storage medium storing a computer program for parking action notification, the computer program causing a computer to execute displaying parking information to an exterior of a vehicle, the parking information being relevant to a parking action of the vehicle when the vehicle performs automatic parking.
